(19) United States
(12) Patent Application Publication
(10) Pub. No.: US 2007/0112775 A1
(43) Pub. Date: May 17, 2007

(54) Method for user biometric artifical authentication

(76) Inventor: David M. Ackerman, San Diego, CA (US)

Correspondence Address: DAVID M. ACKERMAN, 9590 CHESAPEAKE DRIVE 116, SAN DIEGO, CA, 92123, US

(21) Appl. No.: 11/594,272

(22) Filed: Nov. 7, 2006

Related U.S. Application Data
(63) Continuation-in-part of application No. 10/417,689, filed on Apr. 16, 2003, now Pat. No. 7,162,475.
(60) Provisional application No. 60/373,697, filed on Apr. 17, 2002.
(60) Provisional application No. 60/373,736, filed on Apr. 17, 2002.

(51) Int. Cl. G06F 17/30

(52) U.S. Cl. 707/9

(57) ABSTRACT

A system for verifying, authenticating, and processing membership information to generate a selectively approved searchable membership database, viewable through a computer information network, such as the internet. membership verification includes a first processing unit (200) for transmitting data native biometric data to a second processing unit (204) for artificial rendering by a lab processing module (300) stores settings in a database (301). Artificially rendered biometric data is used for reference physical configuration of a first processor biometric capture device (301) Artificially rendered biometric data is used to reference the identity of a native capture device source (301) Artificial rendered biometric data is used in a pass code configuration to activate a biometric capture device (301). A custom user biometric data reference module is used for member users to create a custom biometric data reference database (303). A controlled biometric capture device by second processor is used with the custom biometric data reference database to provide multiple security encryption form identification and verification of a member user.

This application is a continuation in part of U.S. patent application Ser. No. 10/417,689 “Method for User Verification and Authentication and Multimedia Processing for Interactive Database Management and method for viewing the Multimedia” filed on Apr. 16, 2003 which claims priority to U.S. Provisional Application No. 60/373,697 filed Apr. 17, 2002, and No. 60/373,736 filed Apr. 17, 2002.

### FIELD OF THE INVENTION

The present invention relates to a method for creating biometric data using two processors to capture digital images, video and digital audio data, for identification of a native biometric capture device, and authenticating a member or user seeking access to a selectively approved information database viewable through a computer information network.

### BACKGROUND OF THE INVENTION

Online financial services, electronic medical records, and dating services have been in operation for several years that require high levels of security in order to protect confidential information and authenticate the online member user. Internet security and internet user identity have been a perplexing problem using conventional key board alpha-numeric pass code identification technology. Alpha numeric pass code theft is well documented and has resulted in widespread identity theft and financial losses to consumers using the internet.

Some conventional systems take advantage of a computer keyboard in this process. Security is developed through the use of alpha numeric key strokes to develop a password used as the security key to access profile information and confidential information over the World Wide Web (“the Internet”).

Unfortunately, because the web is largely unregulated. Another disadvantage with current internet financial services, internet credit card processing, internet electronic medical records, and online dating services is that anybody can access the website using another member's password, regardless of whether or not the member obtained permission to use the first member's password. The other subscribers to the service may be completely unaware that they are not communicating with the person the profile was created to represent. Online banking information and electronic medical records have not developed any industry standards for identity protect. Since alpha numeric pass codes using a keyboard or keypad device provide complete anonymity it is nearly impossible to determine if the pass code being entered is being used by the actual user. The theft of alpha-numeric pass codes has became widespread and difficult to identify due to the anonymous nature of keyboard technology. Anyone with alpha numeric pass code data can access confidential information on the internet without being the actual end user it was authorized.

Computer keyboard device information transmitted to an on-line dating services, financial service provider or medical record information provider, is anonymous information entered by the member user which can not be verified as accurate or reliable as the intended user. Current internet services omit large amounts of security and legal information, leaving the application service provider compromised with guess work, no biometric verification, no validity of currency of photo images, no legal identity, and alias information may affect candidate verification. As a result, the member user may not really be who or what she claims to be. In addition, it is possible to enroll people with an application service provider, without their knowledge or permission. Further, the anonymous nature of alpha numeric pass codes leaves both the member/user and application service provider vulnerable to security breaches without any true form of identity of the actual member user accessing confidential information.

Thus, people realize that there is a need to assure the integrity of the information presented and the integrity of service. There is a need to assure that the information represented by the member user is true and accurate. There is a further need to provide better safety and security to the member user engaged in using online internet services.

The use of biometric information is currently one method to identify accurate member user through a global information network. There is a need to advance the improvement in capturing images, video, and audio data to facilitate the accuracy of biometric authentication for security verification. Advances in biometric authentication technology provide for improving security environments to accurately identity member users seeking access to a selectively approved information database viewable through a computer information network.

### SUMMARY OF THE INVENTION

The various elements of the present invention have been developed in response to the present state of the art, and in particular, in response to the problems and needs in the art that have not yet been fully solved by current systems for allowing individuals to process accurate and verifiable identity of the user on the web. Accordingly, the present invention provides a method for a second processor to artificially render biometric data, and the pre configured artificially rendered biometric data to identify, authenticate and control a first processing device comprised of a biometric capture device that uses current web technology for allowing individuals safely access confidential personal information on the web.

It is therefore one feature of the present invention to ensure that the biometric data created by a member user (200) is true and accurate through a verification process. Another feature of the present invention assures that the member represented by the profile is the actual member or user using the service through an authentication process.

Another feature of the present invention improves database search capability with audio/video files indexed by unique time dependent biometric identifiers herein known as “biotags” to enable member user access to the audio/video/image files. It is another feature of the present invention to improve a system for controlling live video content through mutual consent approvals and consenting biometric files. Another feature of the present invention improves video and digital image biometric quality recognition and verification processes.

More specifically, the present invention provides a system for improving biometric authentication within a selectively approved membership or user database, for biometrically authenticating a member user, for creating a consenting digital signature and biometric file to control content shared while accessing a selectively approved database, and or access to a virtual meeting, and for improving video communications during a virtual meeting. Member user verification includes a first processing unit (200) for transmitting biometric data to a second processing unit using a software to improve the versatility of the lab processing module (300). The lab processing module is responsible for identifying the parameters of raw biometric data, analyze the digital properties of that data, and pre-configure artificial time dependent biotags elements within the parameters of raw biometric information in such a manner as to be individual unique to each member user and related biometric data capture device used in producing biometric authentication through a searchable database using a computer network.

Another feature of the present invention is the improved use of rendered artificial embedded time dependent biotags within biometric data to identify acceptable native biometric capture devices from one processing unit identified by a second processing unit.

Another aspect of the present invention is the improved use of the lab processing module to artificially rendered time dependent biotags in creating a pass code configuration for activating a biometric device by a second processor unit to a first processor unit through a computer network.

Another aspect of the present invention provides for features of the lab processing module to create a custom user biometric data reference module. The feature of the invention allows the member user to author and create their own biometric reference data which combines biometric data, with time dependant biotags, in establishing a self created biometric reference database associated with the member user profile (303).

Anther feature of the present invention is it provides for a method of improvement biometric authentication combing the improves of the lab processing module and the custom user biometric reference module adding versatility to added security and biometric authentication processing.

Reference throughout this specification to features, advantages, or similar language does not imply that all of the features and advantages that may be realized with the present invention should be, or are, in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a simplified block diagram flow chart of the present invention. The creation of raw biometric data by a member user requiring a processor and biometric capture device. A second embodiment of the present invention is the use of a lab processing module and related database by a second processor or server to define the measurable parameters of raw biometric information of member user, analyze the digital properties of raw biometric data, and incorporate artificial pre-defined and time dependent biotags elements which are embedded within the parameters of raw biometric data creating a independent unique profile comprising rendered biometric file with embedded artificial data to be recorded in a database for an associated member user. A third embodiment of the present invention is the improvement to the lab processing module in the use of rendered biometric data (301) used by a second processing unit such as a server to configure the physical output of the biometric capture device data from a first processing unit to control and govern the input of biometric information from the member user (102).

In a forth embodiment of the present invention is the application of independently profiled data rendered by the lab processing module that combines biometric data with artificially embedded time dependent biotags created by a second processor such as a server to identify and define parameters of an acceptably compatible first processor native physical biometric data capture device. A fifth embodiment of the present invention is the application of independently profiled data rendered by the lab processing module that combines biometric data with artificially embedded data by a second processor such as a server to establish a pass code configuration to physically activate a first processor biometric data capture device. In a fifth embodiment of the present invention is custom reference biometric data module for member users. The member user is allowed to author their own biometric reference files for their associated profiles, which combine the elements of raw biometric data with artificially embedded biotags data using global computer network. In a sixth embodiment of the present invention is the improvement of the biometric authentication module which combines the processes of the lab processing module with the custom user biometric data reference module for improved security and biometric authentication through a computer network.

FIG. 2 illustrates a simplified block diagram using a first processing unit and capture device to produce raw biometric data to a second processing unit such as a sever using a global computer information network according to one embodiment of the present invention;

FIG. 3 illustrates a simplified block diagram for processing raw biometric data such as digital images, video, and audio by a second processing unit comprised of a lab processing module (300) that embeds dynamic time dependant biotags such as artificial computer processor generated, track hinting, hotspots, audio, video correction, and watermark finishing which can be produced singularly or in a plurality of time dependent variables in any digital array, color, location, pattern within the parameters of defined biometric data as added encryption elements for creating a second database of boated biometric data (301), used for identifying a biometric capture device, configuring a pass code to active a capture device, and reference tools for member user custom created biometric reference database (303) and improved authentication processing (709) according to the embodiments of the present invention;

FIG. 4A illustrates a simplified diagram illustrating an example of raw biometric database information using the lab processing module rendering embedded time dependent biotags “hotspots” and stored into a database according to one embodiment of the present invention.

FIG. 4B illustrates a simplified diagram illustrating an example of raw biometric database information using the lab processing module rendering embedded time dependent biotags “hint tracks” and stored into a database according to one embodiment of the present invention.

FIG. 5 illustrates a simplified block diagram illustrates an improved lab processing module (300) comprised of a second processing unit processing unit such as a server to configure the physical capture output of an image sensor device which controls and governs the input capture of biometric information produced by the member user. In addition the illustration combines a custom user biometric data reference module to expand the versatility information through member user self generated and authored biometric reference data (303) according to one embodiment of the present invention.

FIG. 6 illustrates a simplified block diagram illustrates an improved lab processing module (300) comprised of a second processing unit such as a server to configure the capture binary code output of an analog to digital converter device which controls and governs the input capture of biometric information produced by the member user. In addition the illustration combines a custom user biometric data reference module to expand the versatility of information through a member user self generated and authored biometric reference database (303) according to one embodiment of the present invention.

FIG. 7 illustrates a simplified block diagram illustrates an improved biometric authentication module combining the tandem benefits of the lab processing module and custom user biometric data reference module as a method for a member user to self author and create custom biometric reference database with artificially embedded time dependent biotags element for improving biometric authentication and security access to selectively approved information database viewable through a computer information network, according to one embodiment of the present invention.

FIG. 8 illustrates a simplified block diagram illustrates an improved lab processing module from a second processor such as a server to compare rendered biometric data with time dependent biotags elements for identification and verification acceptable native physical biometric capture device from a first processing unit for the purpose of improved security through biometric authentication using a computer network, according to one embodiment of the present invention.

FIG. 9 illustrates a simplified block diagram illustrates an improvement to lab processing module using a second processing unit such as a server providing to create a pass code method comprised of rendered biometric data with embedded time dependent biotags element to physically activate an identified native biometric capture device used by the first processing unit to communicate biometric information to a second processing unit, using a computer network, according to one embodiment of the present invention.

### DETAILED DESCRIPTION OF THE PREFERRED EMBODIMENT

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

In one embodiment, the raw biometric data (203) is transmitted from first processor image (201a) or audio (202b) capturing processing devices to a second processing unit such as server, or processing unit (204), collects the raw biometric data information and stored in a raw biometric database (205) using a computer network.

The member user (200) creates a video or photographic image file and an audio file (“raw data”) that uniquely identifies the member's physical image and audio. For example, the member/user (200) may use the web camera, digital video device, digital camera, camera phone, wireless device or other recording means to record visual representations of the member/user (200), such as physical appearance, facial image, finger printing, or other human body attributes to produce raw biometric data information. Additionally, the member/user through the use of a microphone device (201b) may recite a scripted phrase which may be used to create a biometric file. The biometric file, for member authentication purposes, is a sample of audio/video of the member user (200), which has been processed to turn digitized time dependent signals into wavelength/amplitudes, on a certain number of words and/or frames of video, and the biometric parameters of a digital image and storing them in the database. The biometric file is configured to serve as an additional security feature

The raw data, including the scripted phrase, is transmitted from the client device (101b) and subsequently transmitted to the server (204). The raw data may be transmitted automatically to the server (204) when the interface is launched, or on member (200) command. The server (204) captures the raw data, which is processed and tagged with time dependent biometric identifiers (“biotags”) using a digital video/audio lab module (300). A digital video lab data is stored in a database (301), and such data is associated with profile creation module (302), processes, identifies, and tags unique digital video and audio data from the raw data produced by the member (200) and processes the scripted phrase to create a biometric file. Time dependent biotags are artificial embedded element within the biometric content previously identified and rendered in processing that are correlated and matched with unique identifiers such that SQL or XML queries may quickly and efficiently fetch the requested information. Biotags can include “an extract a single or multiple biometric elements within parameters of the existing content of biometric data such as a portion of an eye, ear, or noise, or in combination as a biometric identifier, or can include a combination of artificially created patterns in conjunction with the biometric identifiers.

Rendered biometric data with artificial embedded time dependent biotags (301) is then used for as reference information for comparison of native biometric source data from the original native biometric capture device acceptable by a second processor from a first processor in a computer network. In another embodiment the rendered biometric data (301) is used for pass code biometric native device activation through a computer network. In a separate embodiment, the rendered biometric data (301) is used for creating a customer user biometric reference database (303).

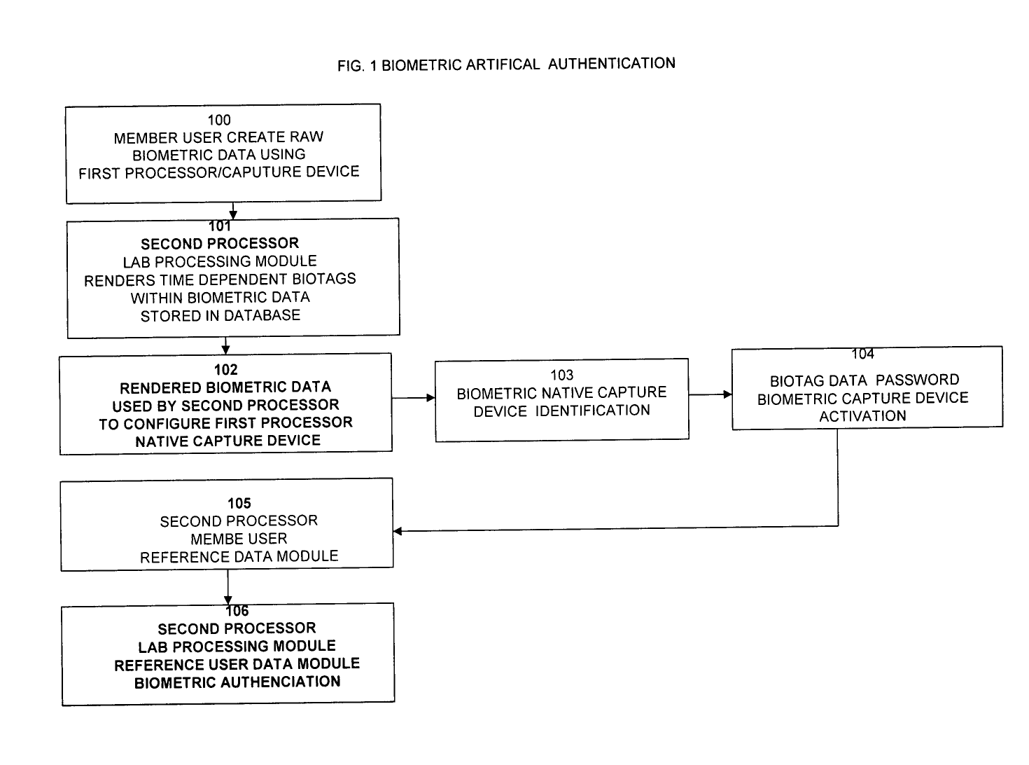

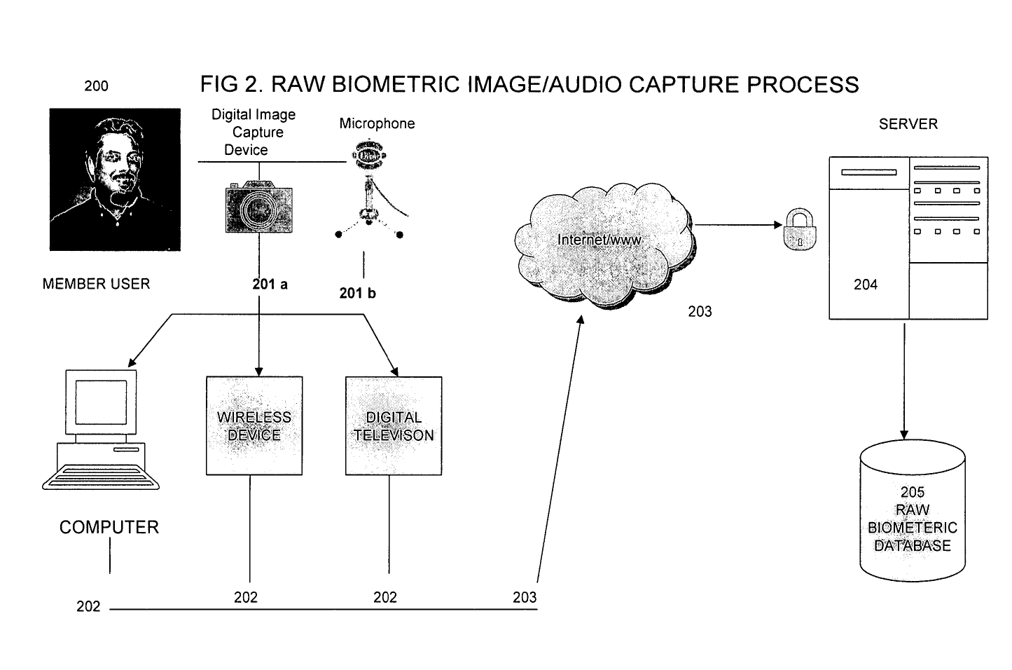

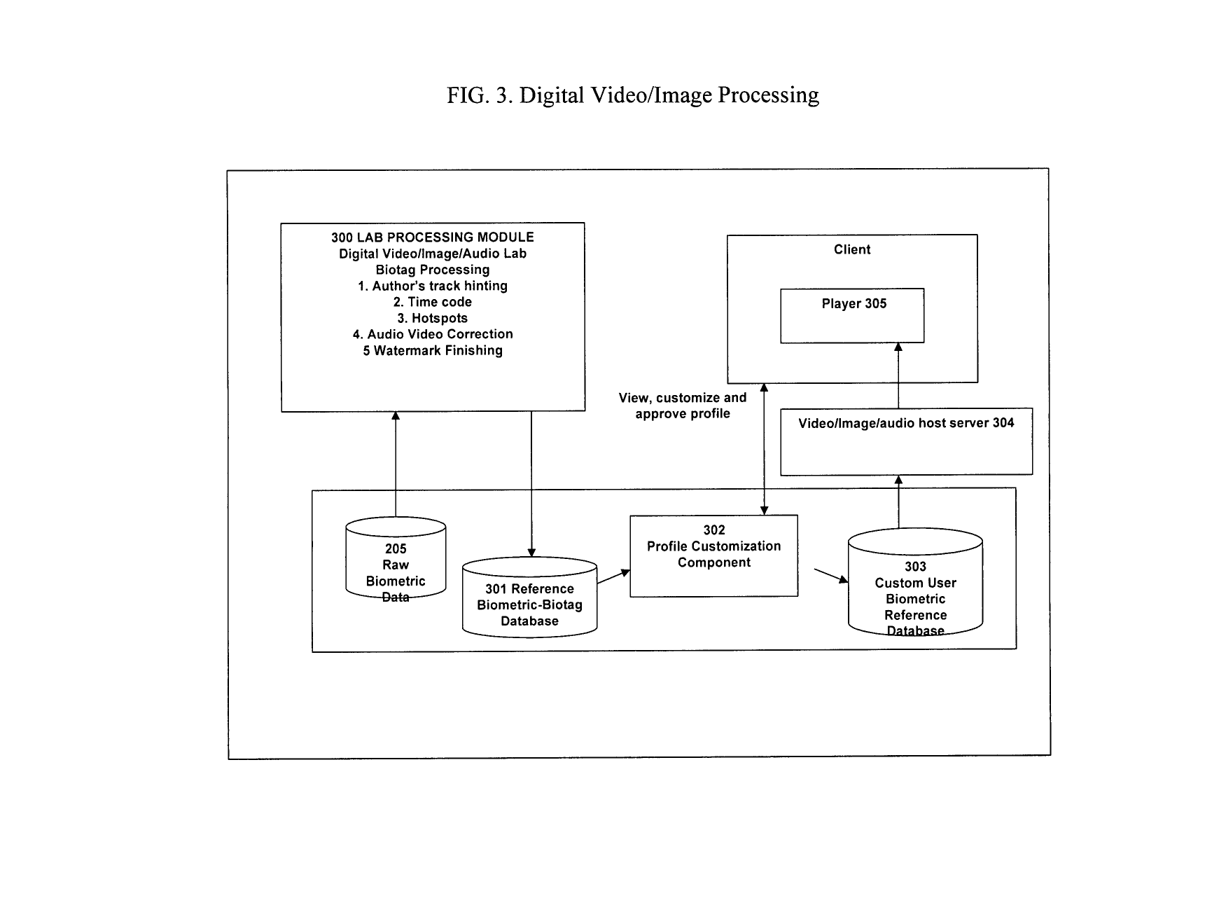

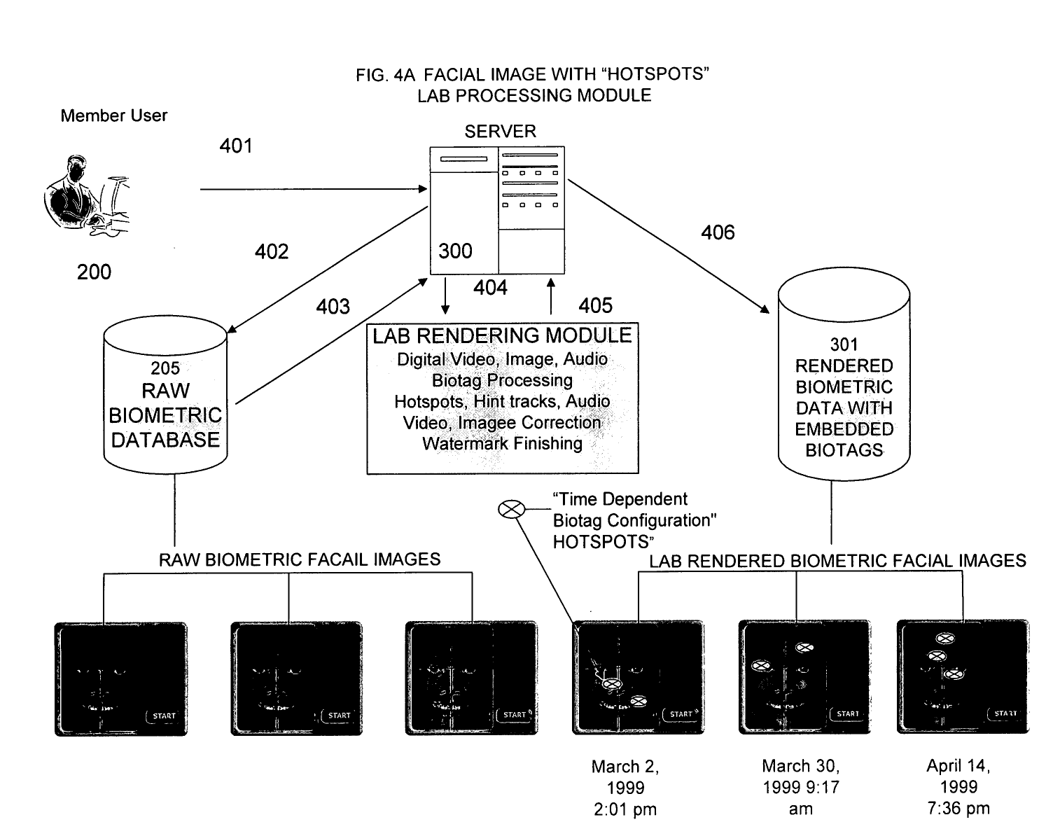

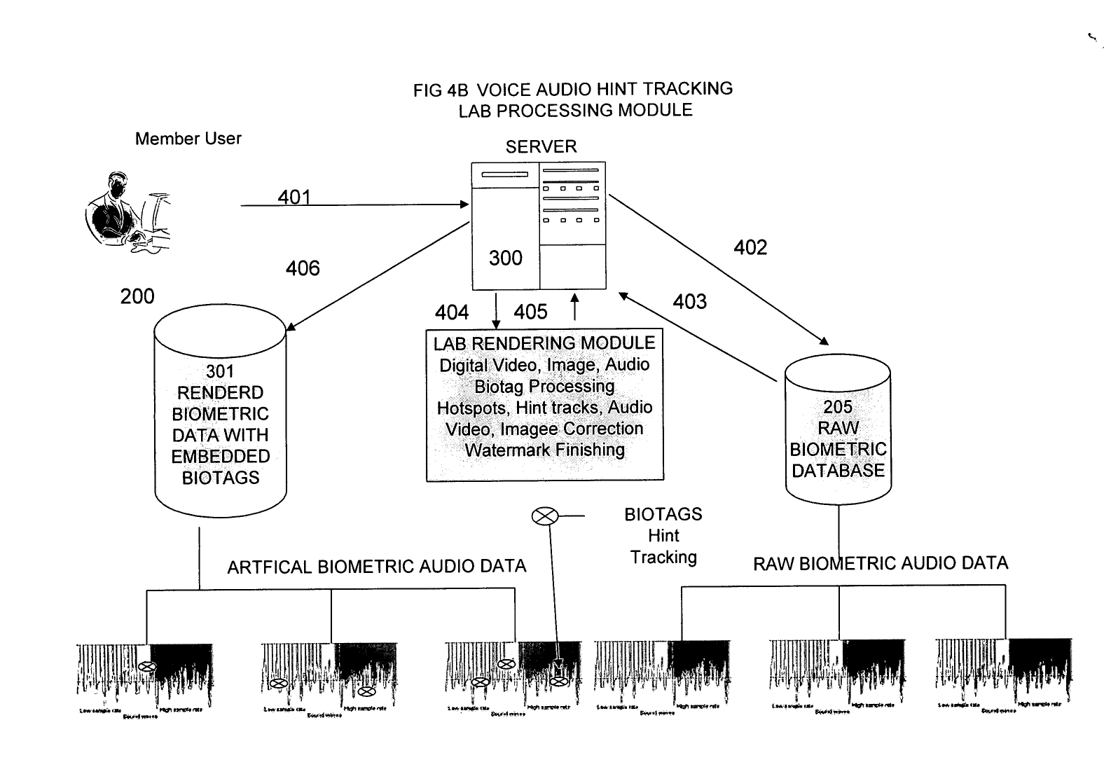

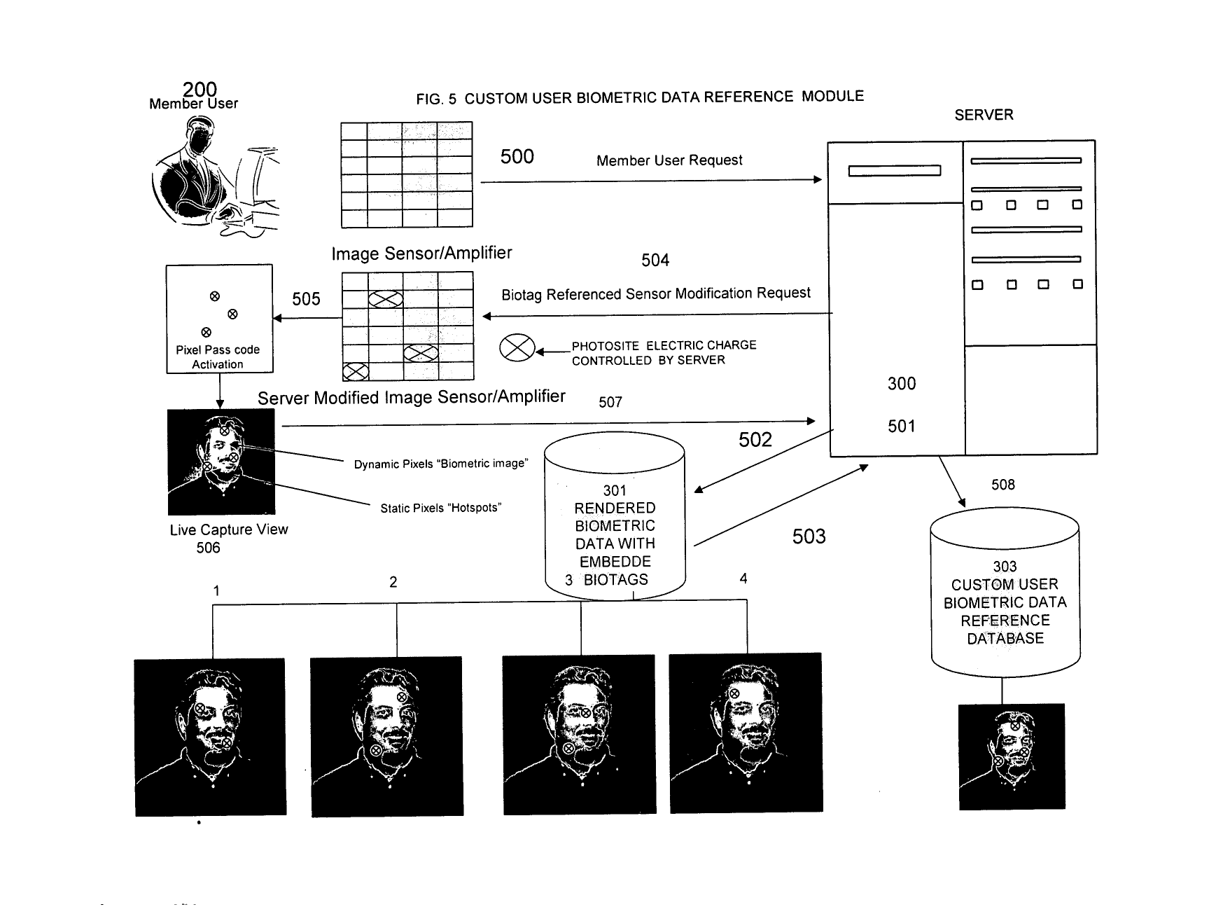

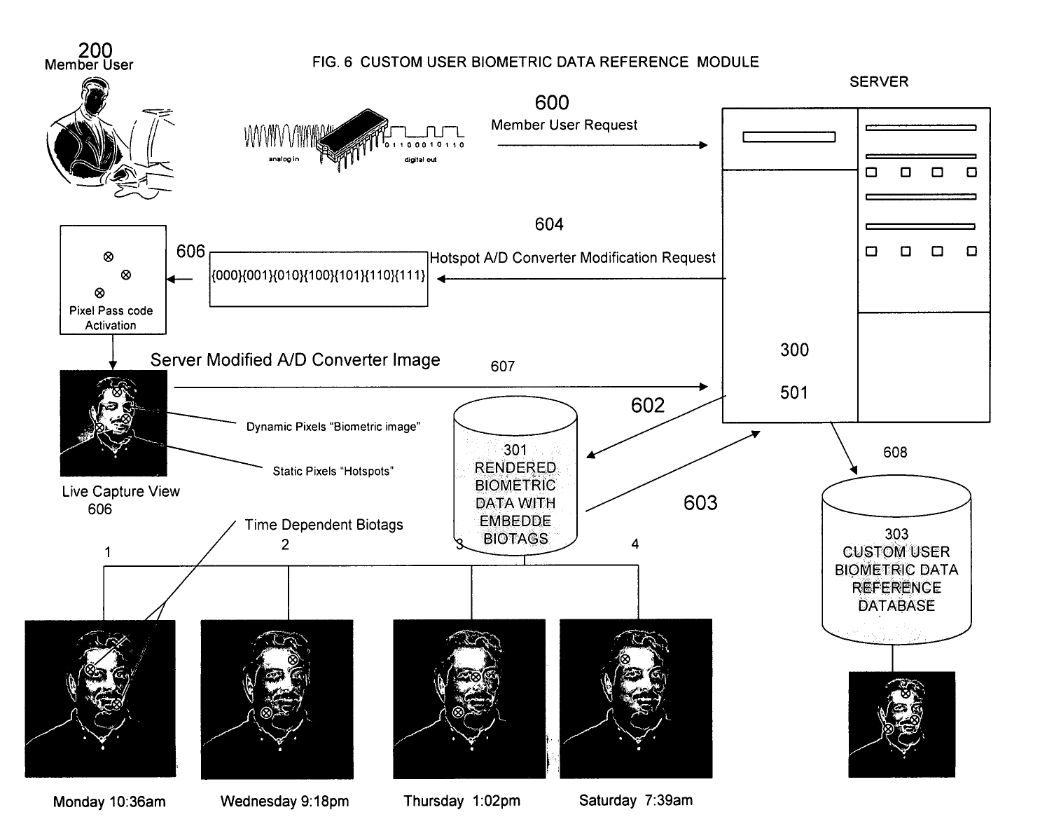

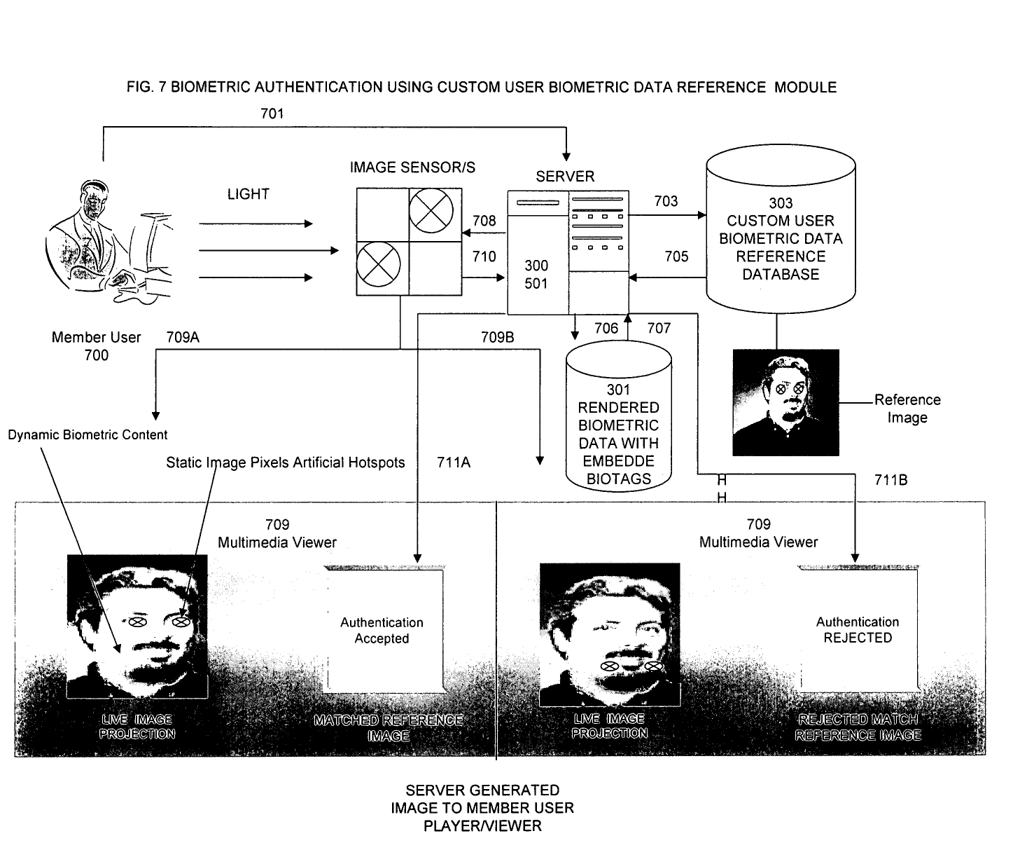

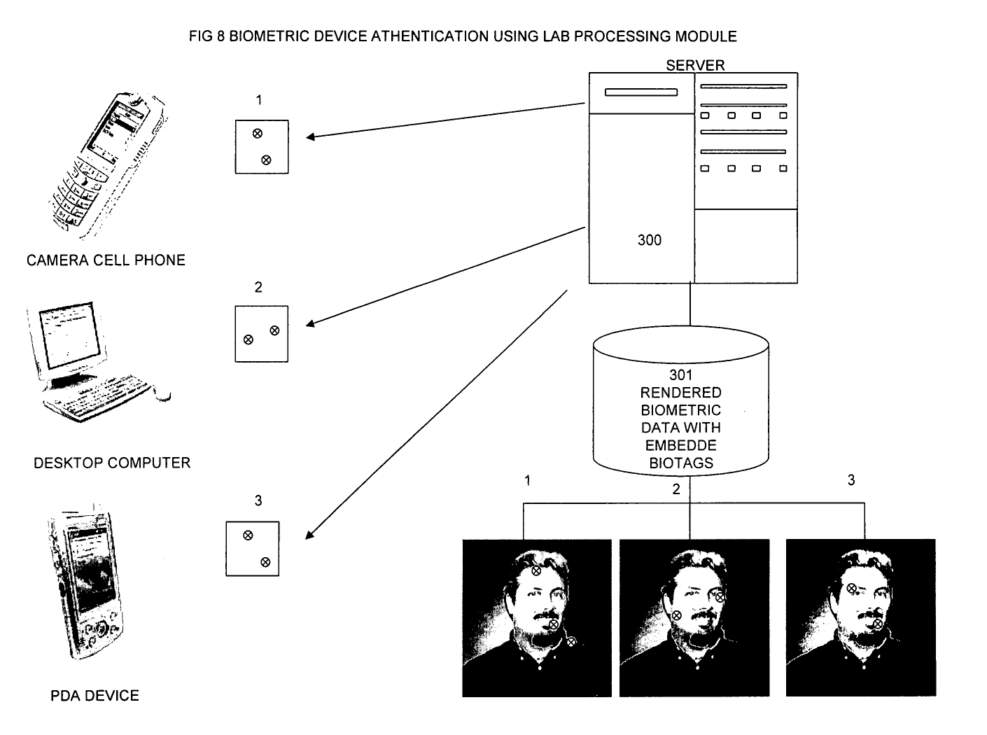

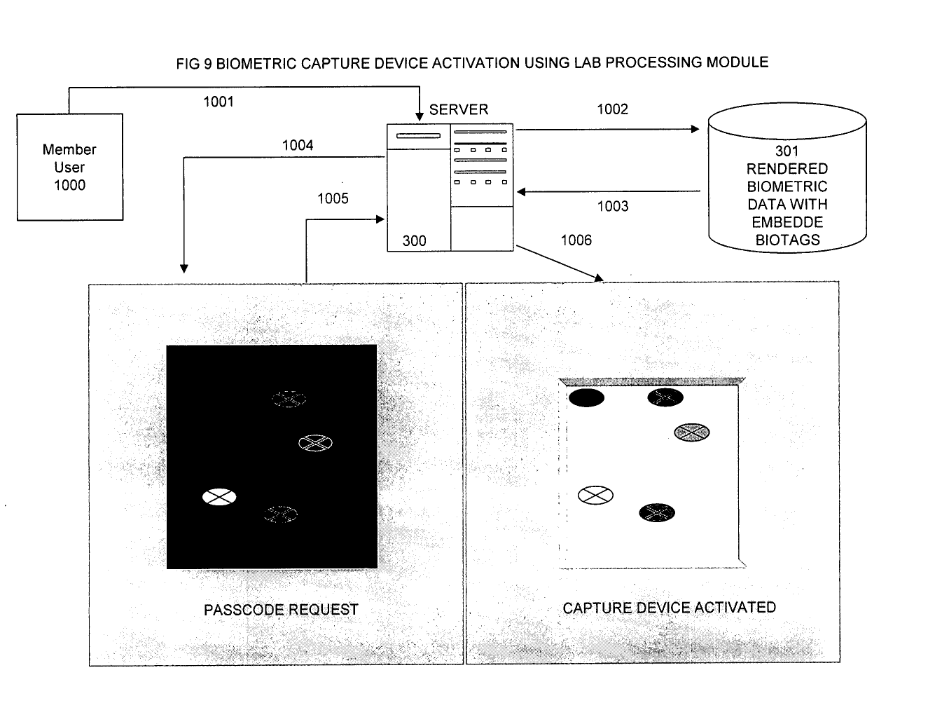

FIG. 1 illustrates a simplified block diagram summary of embodiments of the present invention. The creation of raw biometric data by a member user requiring a processor and biometric capture device (100). The second embodiment of the present invention is the improve use of a lab processing module and related database by a second processor or server to define the measurable parameters of raw biometric information of member user, analyze the digital properties of raw biometric data. The improved lab processing module can incorporate artificial pre-defined time dependent biotags elements such as artificially computer generated pattern array in combination with extracted preexisting biometric components such as a portion of an eye, ear, or nose which are variably rearranged and embedded in the parameters of the original raw biometric data. The lab process module creates a independent means for developing a unique member user profile comprised of a single or multiple rendered biometric file information with embedded artificial data to be recorded in a database for an associated member user (101). A third embodiment of the present invention is the improvement to the lab processing module in the use of rendered biometric data (301) used by a second processing unit such as a server to configure the physical output of the biometric capture device data from a first processing unit to control and govern the input of biometric information from the member user (102). A fourth embodiment of the present invention is the application of independently profiled data rendered by the lab processing module that combines biometric data with artificially embedded data by a second processor such as a server to identify and define parameters of an acceptably compatible first processor biometric data capture device (103). A fourth embodiment of the present invention is the application of independently profiled data rendered by the lab processing module that combines biometric data with artificially embedded time dependent biotags by a second processor such as a server to establish a pass code configuration to activate a first processor native biometric data capture device (104). In a fifth embodiment of the present invention is the improvement of the lab processing module for the tandem operation of a custom reference biometric data module for member users to create unique database of combined biometric and artificially embedded reference information. The member user is allowed to author their own biometric reference files for their own associated profiles, which combine the elements of raw biometric data with artificially embedded time dependent biotags data using global computer network (105). In a final embodiment, is an improve to the biometric authentication module combining the benefits of the lab processing module and the custom user biometric reference data module requiring a second processor to configure a first processor capture device physical output and compare the input of said biometric data with custom user biometric reference database profile information for biometric authentication seeking access to a selectively approved information database viewable through a computer information network.

In one embodiment a member user creates “raw” biometric information data from a first processing unit which could be a desktop computer, laptop computer, wireless devices such as a cell phone, or a interactive television such as a set top box with image, video, and audio capture capability. Raw biometric data can be produced independently or in plurality in the form of images, video, or audio information comprised of personal information representative of a member user. The raw biometric data from the member user (200) is then send from the first processor unit to a second processor unit (204) such as a server and stored in a raw biometric database (205).

FIG. 2. illustrates a simplified block diagram illustrates a member user (200) using a processing unit image capture device (201a) and or an audio capture device such as a microphone (201b) which can be used independently or in plurality of each other for capturing raw biometric data. The digital image capture device or audio capture device can be use in association with a computer, wireless device such as a cell phone or PDA, or an interactive television, such as a set-top-box (202). Captured raw biometric data is then send from the first processing unit (203) to a second processing unit (204) using a global information network such as the internet. Second processing unit store raw biometric data in a database storage unit (205).

In another embodiment a second processor or server utilizes a lab processing module, the server (300) is configured to identify and define the exiting parameters of biometric data stored in the raw biometric database (205). The lab processing module analyzes the biometric information rendering embedded biotags elements such as hint tracks, hotspots, time coding configurations, audio and video correction and watermark finishing. Biotags digitally layer unique objects and shape characteristics isolated within the image, and referenced by color, gray scale, location, patterns, or combined elements of pre defined extracted elements from the original raw biometric data such as a portion of an eye, ear, noise from identification for each referenced member (200).

The lab processing module combines artificially computer generated time dependent biotags information rendering original raw biometric data, thus producing artificially rendered biometric information that comprise multiple elements of encryption, biometric and artificial data within a single reference user profile. The improvement to the lab processing module can produce artificially rendered biometric data that is time dependent, producing an array of data, which can produce multiple biometric/artificial reference data independently or at random varying time intervals, which could include independent reference media such as a single image, multiple images, video, audio, or a combination of all to compromise rendered biometric data for a member user profile identity (301).

FIG. 3. illustrates a simplified block diagram illustrates the use of a digital video, image audio lab processing module. Raw biometric data from database (205) is generated by second processing unit which could be an internet server. The lab processing module through the use of software artificially biotags raw biometric information embedding track hinting, time codes, hotspots, audio and video correction, and watermark finishing (300). Embedded biotags can be randomly embedded on time dependant variables, simultaneously on receipt of raw biometric data, or reconfigured at a later time. Render biometric data with embedded biotags parameters produced by the lab processing module are then are then stored in a database by the second processing unit (301). The biotagged information is then identified with a member user's general profile Information (302) and stored in the member users profile library (303). Member user authored and created biotagged data information is available for future reference by the lab processing module by the second processing unit for future biometric authentication (304). The second processor can then use time dependent biotags information for biometric authentication, device identification, and establishing pre-defined control setting for the first processing device utilizing an image or video capture device or audio capture device. The client multimedia player viewer is used to view the authentication process produced by the second processing unit or server (305).

The improved lab processing module (300) can extract pre defined biometric elements within the existing parameters of the original raw biometric data, and artificially rearrange such data, such as extracting the biometric data of the left eye and replacing such data on the chin and rearranging the biotags elements “hotspots” in an artificially pre arranged pattern, location, color, or location, or in combination with artificially produced array of patterns, color, or location. In the case of audio data, the rearrangement of a word within a designated phrase as a hint track. Since the biotags are time dependent the information references can be dynamic in their reference arrangements.

FIG. 4A illustrates a simplified block diagram illustrates the use of a digital video, image audio lab processing module embedding biotagged “hotspots” to create an artificially rendered biometric database. The member user (200) through using a first processing unit to capture an image, video raw biometric data is captured and sent (401) to second processing unit (300) The second processing unit stores raw biometric data to a database (402). The raw biometric data can be simultaneously retrieved by the second processing unit or at a later time by the lab processing module (403). The lab processing module consists of software residing on the second processing unit (300). Upon receipt of the raw biometric data (403) The lab processing module in the illustrated example analyzes the raw biometric facial image data (404) The lab module in embeds “hotspot” biotags within the biometric facial images to produce a rendered biometric image with embedded biotags (405). The newly rendered image with artificial embedded biotags parameters are recorded within the biometric data, the second processing unit or server than stores the parameter settings (406) in to a rendered biometric database which comprise the embedded biotags element (301) information (404).

FIG. 4B illustrates a simplified block diagram illustrates the use of the lab processing module for audio rendered embedded biotags “Hint Tracks” to create an artificially rendered biometric database. The member user (200) through using a first processing unit to capture audio raw biometric data is captured and sent (401) to second processing unit (300) The second processing unit stores raw biometric data to a database (402). The raw biometric data can be simulations retrieved by the second processing unit or at a later time by the lab processing module (403). The lab processing module consists of software residing on the second processing unit (300). Upon receipt of the raw biometric data (403) The lab processing module in the illustrated example analyzes the raw biometric audio data (404) The lab module in embeds “hint track” biotags within the biometric audio data to produce a rendered biometric data with embedded biotags (405). The newly rendered data with artificial embedded biotags parameters are recorded within the biometric data, the second processing unit or server than stores the parameter settings (406) in to a rendered biometric database which comprise the embedded biotags element (301) information (404).

In another embodiment of the present invention is a custom user biometric data reference module. The member user is provided a versatile platform to create and author their own custom generated biometric reference database, which includes artificially rendered static biotags elements combined with live dynamic biometric data which could be video, images, or audio, or combinations. The custom biometric data reference module works in conjunction with the lab processing module to add variable artificial configuration elements in the rendering process. The biotags elements are time dependent and can be configured in multiple arrays changing over time. The member user creates the custom biometric reference data using a second process or server which is controlled by time dependent configuration control settings of the first processor unit biometric capture device through a computer network. The member user with a pre-configured capture device regulated and controlled by the second processing unit can create custom biometric data which embeds the artificial biotags elements in the rendered data. As an example, the member user can recite any word phrase for biometric audio reference, but the biotags place specific hint tracks in the time code to identify the rendered biometric reference data to be stored in the custom user biometric database (303). In an example of an image, the member user has full control over the authoring of the dynamic array of live biometric data prior to capture, and can select correlated custom photo image alignments referenced to facial features in relationship to the static biotags data projected in the user viewer through a computer network. The member user then captures the image and stores it in the database for future biometric authentication (303). only the originating author member user is familiar with the custom reference image that must be produced for biometric authentication.

FIG. 5 illustrates a simplified block diagram illustrates the use of lab processing module creating a method for a member user to create a custom biometric reference database through a member user biometric module. The member user (200) seeking access to a selectively approved information database viewable through a computer information network (500). A server representing the second processing device comprised of reference image module controlled by software (501). The second processing unit (501) retrieve information (502) from the rendered biometric database (301). The database information is then sent from the database to the second processor (503). The member user reference image module locates previously rendered biotags data from the member user. The software using pre-defined biotags data remits referenced biotags information to the first processing unit (504). In the illustration the first processing unit is comprised of an image sensor device with amplifier. The second processing unit emulates the biotags information to control and govern photosite electrical charges and current in the image senor and or amplifier. The controlled photosites create a static pre-defined pixel array output by the second processing unit. The static pixels send by the second processing unit to the first processing unit become visible through the member user viewer (505). The member user is required to complete a pass code identification sequencing referenced by the static pre-determined pixel array to activate the image capture device (505). A detailed of this embodiment is further discussed in more detail in FIG. 9. Using the correct pass code sequencing the image capture device is activated to produce a full image senor display image (506). The display image consists of static pre-defined biotags element as illustrated in the example which uses “hotspots”, which includes dynamic pixel array consisting of biometric data allowing a member user to create a custom biometric reference image which is discussed in further detail in FIG. 7. The member user through the live image, creates a still captured image and remits inputted biometric information from the image capture device with matching biotags “hotspots” to the second processing unit (507). The second processing unit then store the member user created biometric reference image into their profile database (303).

Similarly, using the improved lab processing module a digital photography image or video frame, using a custom time dependent biotags template or mask, which as an example, the member (200) may transmit a photo image of himself; a custom biotags mask is digitally layered within the original raw biometric data produced facial image content, the mask highlights can highlight shapes or portions of the eyes, hair, nose, etc., and captures color characteristics and locations of biometric data. The biometric file may be created by parsing the color information, scaling the color characteristics, and creating a custom color chart for the identified object stored in a database (301). The rendered settings comprised of native biometric data and artificially embedded biotags references from the associated member user profile are use by a second processor unit to configure a first processor unit biometric capture device. The capture device is regulated by statically controlled artificial captured output which is rendered with the raw biometric data created by the member user. The member user using a pre-configured capture device can create custom biometric data with pre-defined biotags elements in creating a personal biometric reference database for biometric authentication providing a duel encryption of combined biometric data with artificial data within a single property profile.

FIG. 6 illustrates a simplified block diagram illustrates a method for a member user to create a custom biometric reference database through the member user reference image module. The member user (200) seeking access to a selectively approved information database viewable through a computer information network (500). A server representing the second processing device comprised of reference image module controlled by software (501). The second processing unit (501) retrieve information (502) from the rendered biometric database (301). The database information is then sent from the database to the second processor (503). The member user reference image module locates previously rendered biotags data from the member user. The software takes pre-defined time dependent biotags data and remits referenced biotags information to the first processing unit (504). In the illustration the first processing unit is comprised binary code produced by an analog digital converter. The second processing unit emulates the biotagged information by writing new binary software code. The new binary code creates a static pre defined pixel array by the second processing unit. The static pixels send by the second processing unit to the first processing unit become visible through the member user viewer (505). The member user is required to complete a pass code identification sequencing referenced by the static pre-determined pixel array to activate the image capture device (505). A detailed of this embodiment is further discussed in more detail in FIG. 9. Using the correct pass code sequencing the image capture device is activated to produce a full image senor display image (506). The display image consists of static pre-defined biotags element as illustrated in the example which uses “hotspots”, which includes dynamic pixel array consisting of biometric data allowing a member user to create a custom biometric reference image which is discussed in further detail in FIG. 7. The member user through the live image, creates a still captured image and remits the biometric information with matching biotags “hotspots” to the second processing unit (507). The second processing unit then store the member user created biometric reference image into their profile database (303).

In another embodiment of the present invention, the lab processing module working in conjunction with the custom user biometric data reference module, provide added versatility to the authentication process. In on instance the lab processing module is allowed to artificially pre-define and reconfigure biotags elements within the existing parameter of biometric information by way of the lab processing module. In addition the member user is provided with authoring capabilities to customize biometric data using the availability of biotags elements to create their own personal unique biometric reference data using a computer network. The expanded variables of both artificial created information in conjunction with biometric data provides a multiple array of encryption capabilities within in a single reference component or with multiple biometric reference components for biometric authentication.

FIG. 7 illustrates a simplified block diagram illustrates a biometric authentication module processing by a member user through a global information network. The authentication module uses pre-configured biometric artificial biotags rendered by the lab processing module (300), and accessible database that stores lab processed information for each selective profile user or member (301). In addition the authentication module is compromise of a custom user biometric data reference module (303). In the illustration of the biometric authentication module, the member user (700) remits a request from a first processor unit to a second processor unit seeking access to a selectively approved information database viewable through a computer information network (701). The second processing unit or server consists of a custom user biometric data module (501), which is accessed through member user reference database associated with each member or users profile (303). The biometric authentication module is involved in a two set process. First the second processing unit obtains the members user customer biometric reference data from (703). Second the lab processing module retrieves stored data configurations of previously rendered biometric data, which included artificial biotags elements (301) The server or second processing unit using member profile information requests member user previously custom created biometric reference information (703) Where as member user biometric database consists of images, video, and audio which act as biometric authentication reference information, which can be authenticated as separate references or in plurality for biometric authentication. In the example illustration the reference is a still facial image with embed biotags “hotspots” (704). The member user customer biometric information is sent from the member user database to the second processing unit or server (702). The second processing unit makes a request for lab rendered biometric data with embedded biotags associated with the members profile, and prior lab rendering history of previously processed biometric information, keeping a log file of lab rendering information including “hotspots”, “hint tracking”, parameters for each associated member user. The lab processing module compares pre-determined biotags settings with the member user custom biometric reference information (702). The lab rendering module then sends the parameter coordinates of the embeded biotags to emulate the capture device, in the example illustration the capture device is an image sensor (708). The server controlled image senor transmits a live image to the member user multimedia viewer for biometric authentication. In the example the embedded biotags are “hotspots” which static pixels controlled by the server to the image sensor device. The remaining pixel array is dynamic with motion. The member user is required to remember the alignment of the biotagged hotspots in association with other facial information. In the example, the member user, previously created a biometric reference image aligning the server controlled “hotspots” over both eyes. The member user aware of the alignment configuration duplicates that alignment with a still capture in (709A). The image is send from the first processing unit to the second processing unit or server for biometric authentication (710). The captured image is compared with the reference image which analyses information from biometric data, and artificially created biotags elements. In the instance of (709A) the captured image matches the customer reference image and authentication is accepted, and access to a selectively approved information database viewable through a computer information network is granted. In the example of (709B) the member user is not aware of the correct alignment of biotagged “hotspots” and the capture image transmitted to the server (710) is analyzed comparing biometric information with biotagged “hotspots” to the custom biometric reference member information do not compare in which biometric authentication is rejected (711B) and the member user is denied access to a selectively approved information database viewable through a computer information network is granted.

In another embodiment of the present invention is the improvement of the lab processing module (300) to provide time dependent biotag reference data in the identification of a member user capture device. Upon receipt of native raw biometric source data, the lab processing module provide a unique biotag configuration to identify future inquires by the native capture device, in which setting are stored in a database (301). The process adds an added measure of security to define acceptably compatible biometric capture devices suitable for biometric communications with the second processing unit or server. The member user can receive separate identification for each device used for biometric communications. The benefit limits the scope of access to biometric communications targeted for a specific member user through a computer network.

FIG. 8 illustrates a simplified block diagram illustrates using the lab rendering module to authenticate a biometric device. The lab processing module upon the initial rendering of raw biometric data embeds biotags of which the example illustrates “hotspots” into a pixel array. The lab processing module upon receipt of the raw biometric data configures biotags settings from the original capture device which produced the raw biometric data. The biotags setting are stored in the rendered biometric database (301). In the illustration, the embedded biotags in image number “1” reference a camera phone device. In image number “2” a desktop computer, and in image number 3 a PDA device. The embedded biotags for image number 1 match the pre-determined parameters established for the image sensor in the camera cell phone. The second processing unit through the lab processing module provides for capture device activation. The benefit of device authentication is it provides additional security allowing the second processing unit to control device access for authentication. Each device has a distinctive embedded biotags element within the existing biometric data for controlling security and identification

In this embodiment of the present invention is a method for activating a biometric capture device with pass code configured by the second processing unit or server, and viewed by the member user through the first processor unit multimedia view. The second processor retrieves pre-configured settings rendered by the lab processing Module and stored in a database (301). The settings are then transmitted from the second processor unit to the first processor unit capture device and projected through the member multimedia viewer. The user must identify the biotags data configuration arrangement projected through the multimedia viewer as a pass code. The pass code is completed for an image capture device by properly sequencing the static pixel array of biotagged elements projected through the viewer, using a cursor or mouse, or touch screen application. Successful pass code sequencing then activates the biometric image capture device by the second processor unit or server, projecting a live image. In another embodiment of pass code referencing, the multimedia viewer projects a phrase or word to recite as the biotagged information. The member user recites the phrase through the microphone to the second processor unit, upon successful authentication the multimedia viewer is activated with the microphone for additional biometric authentication and verification identity of the member user.

FIG. 9 illustrates a simplified block diagram illustrates using the lab rendering module to activate a biometric device. The member user (1000) seeks access to a selectively approved information database viewable through a computer information network. The lab processing module consist of software operating on a second processor or server (1001). The member user profile information with rendered biometric data that consists of embedded Biotags is called from the database (301). Information from the rendered biometric data is sent to the lab processing module to reference pre-configured biotags settings identified in establishing the member user's profile (1003). The lab processing module from the second processor or server identifies the biotagged coordinates within the biometric rendered file, and transmits parameter setting to the capture device used by the first processor. In the illustration “hotspots” are used and projected in the member user's multimedia player (1004) The member user through the use of a curser must highlight the projected static pixel array projected by the second processing unit or server in a random method sequence. In the example five “hotspots” are displayed within the multimedia viewer. The user must highlight the “hotspots” with a cursor or mouse or pointing device, or a touch screen, in correct order a combination of choices to activate the full sensor array. The sequence combinations the member user highlights in a selected order are sent to the second processing unit as a pass code (1005). In the example a correct password sequencing is completed, which then activates the capture device. In the illustration, being an image sensor which then provides a full pixel array consisting of dynamic live pixel with motion, and static pixel array defined by “hotspots” controlled by the second processing unit (1006)

What is claimed is:

1. A system for member user to access a selective database through a global computer information network, comprising:
a first processing unit configured to transmit native biometric data relating to a member user personal physical characteristics to a second processing unit;
a lab processing module configured by the second processing unit to amend native biometric data relating to the member user;
a custom user biometric data referencing module configured to amend native biometric data by a member user in creating a database;
an authentication module configured to authenticate a member user using a second processor controlled capture device, and a custom self created biometric reference file with embedded time dependent artificial biometric identifiers when the member user attempts to use the system;

2. The system of claim 1, wherein lab processing module configured by a second processing unit to generate time dependent artificial biometric identifiers within the parameters of native biometric data comprised of physical characteristics of a member user to render a pre-defined biometric database for an associated user or member through a computer network.

3. The system of claim 2, wherein the lab processing module is used to configure a first processor biometric capture device through a computer network.

4. The system of claim 2, wherein the lab processing module provides for identification and acceptance of a biometric capture device.

5. The system of claim 2, wherein the lab processing module provides a password to the member user over a computer network to activate a biometric capture device.

6. The system of claim 1 and 2, wherein custom user biometric data module configured by a second processing unit controlling a biometric capture device from first processor unit for member user to self created and author custom biometric reference data with artificially embedded attributes using a computer network.

7. The system claim 2, 3 and 6 wherein a second process lab processing module controls a biometric capture device output data from a member user compares data with custom user biometric reference database for biometric authentication.
